(19) United States
(12) Patent Application Publication
(10) Pub. No.: US 2025/0165727 A1
(43) Pub. Date: May 22, 2025

(54) AUTOMATED USER INTERFACE TRANSLATION

(71) Applicant: International Business Machines Corporation, Armonk, NY (US)

(72) Inventors: Nan Chen, Beijing (CN); Yin Xia, Beijing (CN); Huai Ying Xia, Beijing (CN); Xiao Juan Chen, Beijing (CN); Xiang Juan Meng, Beijing (CN)

(21) Appl. No.: 18/516,150

(22) Filed: Nov. 21, 2023

(51) Int. Cl. G06F 40/58; G06F 18/232

(52) U.S. Cl. CPC G06F 40/58; G06F 18/232

(57) ABSTRACT

A method, computer system and computer program product to automatically translate and adjust user interfaces is provided. A processor retrieves user interface for translation to a second language, wherein the user interface comprises a plurality of elements in a first language. A processor determines at least one semantic cluster of the plurality of elements. A processor determines at least one location cluster of the plurality of elements. A processor generates a translation of the plurality of elements in the first language to the second language, where the translation of the plurality of elements maintains proximity of i) the at least one semantic cluster of the plurality of elements or ii) the at least one location cluster of the plurality of elements.

### BACKGROUND OF THE INVENTION

The present invention relates generally to the field of machine learning and more particularly to train a deep learning model to categorize and aggregate user interface elements for translations to other languages.

User interfaces provide ways for users to interact with computing programs and systems. Various interface elements or components are placed and arranged by designers to help user interaction. Placement, size, and other factors associated with user interface elements are carefully chosen to promote or improve user interaction. However, this careful placement and design is hard to account for other languages as a concept in one language may take more letters or words to convey the same concept. As such, user interface translations are handled by other teams familiar with the language that will account for such deviations that may occur during translation.

### SUMMARY

Embodiments of the present invention provide a method, system, and program product to automatically translate and adjust user interfaces. A processor retrieves user interface for translation to a second language, wherein the user interface comprises a plurality of elements in a first language. A processor determines at least one semantic cluster of the plurality of elements. A processor determines at least one location cluster of the plurality of elements. A processor generates a translation of the plurality of elements in the first language to the second language, where the translation of the plurality of elements maintains proximity of i) the at least one semantic cluster of the plurality of elements or ii) the at least one location cluster of the plurality of elements.

### BRIEF DESCRIPTION OF THE SEVERAL VIEWS OF THE DRAWINGS

FIG. 1 depicts a block diagram of components of the computing device executing a user interface generator, in accordance with an exemplary embodiment of the present invention

FIG. 2 is a functional block diagram illustrating a networked environment, in accordance with an exemplary embodiment of the present invention.

FIG. 3 illustrates operational processes of training deep learning models to classifying proximal elements in a user interface on both semantic and location relationship, on a computing device within the environment of FIG. 1, in accordance with an exemplary embodiment of the present invention.

FIG. 4 illustrates operational processes of generating a translated user interface based on analysis by a trained deep learning model, on a computing device within the environment of FIG. 1, in accordance with an exemplary embodiment of the present invention.

### DETAILED DESCRIPTION

Embodiments of the present invention realize that maintaining the relative layout of a user interface across multiple translations can be difficult to achieve. The size and space needed for translated text that mat exceed the size and placement of the original element in the initial language can often cause other elements in the user interface to be moved or changed to accommodate the larger amount of text needed for an accurate translation. As such, embodiment of the present invention recognize a need to improve clustering and aggregation of elements such that changes and movement of the user interface elements do not separate related elements due to pagination, render size and other factors that adjust the elements to accommodate the translated text.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as user interface generator 212, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

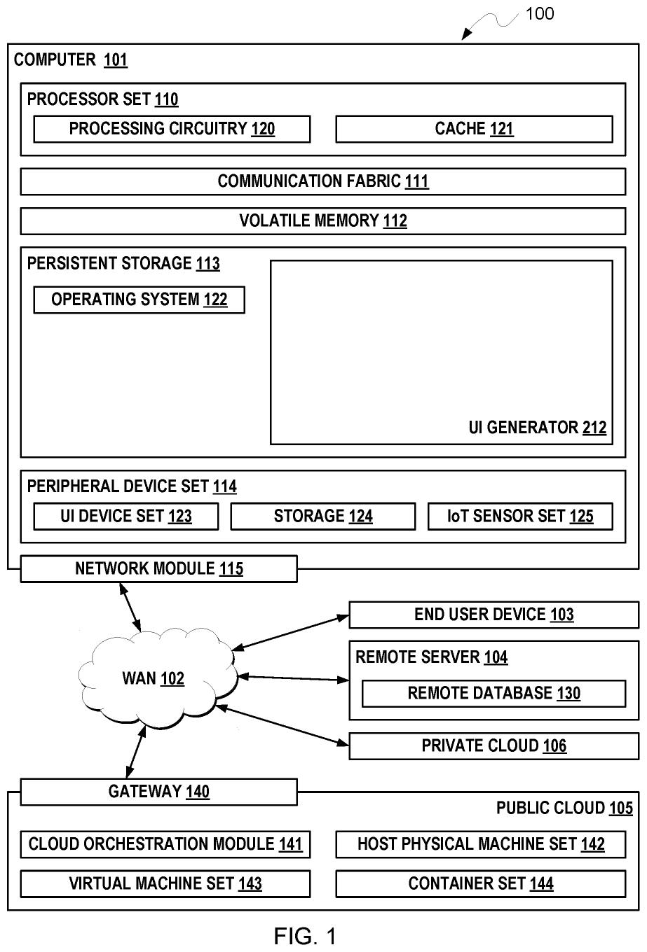

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods (i.e., user interface generator 212) may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

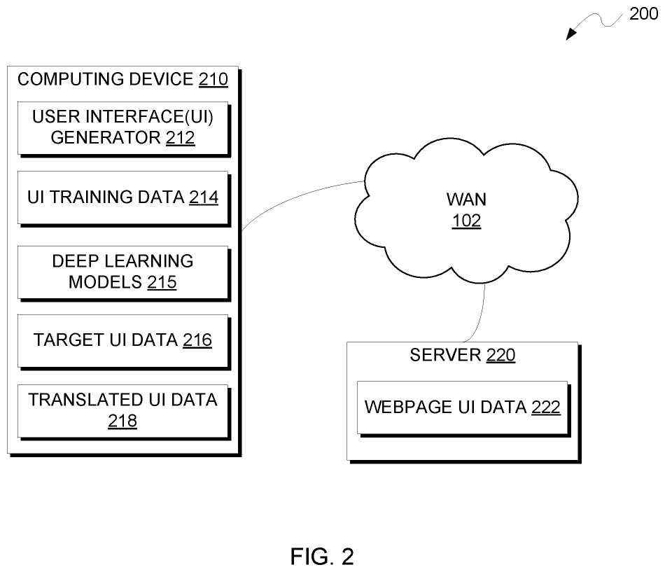

FIG. 2 is a functional block diagram illustrating networked environment, generally designated 200, in accordance with one embodiment of the present invention. Networked environment 200 includes computing device 210 and server 220 connected over WAN 102. Computing device 210 includes user interface (UI) generator 212, UI training data 214, deep learning models 215, target UI data 216 and translated UI data 218. Server 220 includes webpage UI data 222.

In various embodiments of the present invention, computing device 210 and server 220 are each computing devices that can be a standalone device, a server, a laptop computer, a tablet computer, a netbook computer, a personal computer (PC), or a desktop computer. In another embodiment, computing device 210 or server 220 represents a computing system utilizing clustered computers and components to act as a single pool of seamless resources. In general, computing device 210 or server 220 can be any computing device or a combination of devices with access to UI training data 214, deep learning models 215, target UI data 216 and translated UI data 218, webpage UI data 222 and is capable of executing UI generator 212. Computing device 210 or server 220 may include internal and external hardware components, as depicted and described in further detail with respect to FIG. 1.

In various embodiments, UI generator 212 retrieves UI training data 214 to train deep learning models 215. UI training data 214 includes one or more data exchange formats that describes or otherwise represent the contents and arrangement of user interface elements of similar interface (i.e., UI generator 212 is targeting an email UI translation, as such UI training data 214 includes UI data for multiple email interfaces). For example, UI training data 214 is represented using JavaScript Object Notation (JSON). One of ordinary skill in the art will appreciate that any notation or format can be used to represent a user interface without deviating from the invention.

Initially during training. UI generator 212 evaluates UI training data 214 to determine element cluster groups. Various user interfaces have portions of elements that are grouped together. For example, web pages typically have a “top banner” or “side bar” where multiple UI elements reside. In some embodiments and scenarios, UI generator 212 determines clusters of UI elements for a particular user interface based on the notation of the user interface (i.e., nested objects in JSON). In other embodiments, UI training data 214 includes supervised training data in which a user provides clustered elements to the training set. In some embodiments, UI training data 214 also includes a sequence or other relationship of each cluster of interface elements. For example, a cluster of “banner” elements are found in a JSON representation of a website interface, which is followed by a “page tile” element.

For the various elements in UI training data 214, UI generator 212 groups the elements based on several factors. As discussed above, JSON notation of the user interface will include “clusters” via the elements and grouping thereof. Additionally, training data 214 also includes location and rendering data when the user interface is displayed. For each element, UI generator 212 assigns a “page number” to the element. As such, user interfaces may have multiple tabs, panes, windows, or other locations for displaying user interface elements. During training, UI generator 212 notates which “page” the element appears on when rendered. As used herein, “page” notates an overall location of the element in the user interface. For interfaces with tabs or multiple pages like a website, each is assigned a unique page identifier prior to training.

With each page of a user interface identified, UI generator 212 determines the elements contained in each page. In a website interface, each element in a given webpage is assigned the same page identifier (i.e., “P1” . . . “Pn”). Then UI generator 212 assigns each of those elements a unique identifier as well (i.e., “E1” . . . “En”). Additionally, UI generator 212 assigns the name of the element type or key (i.e., the descriptor name of the element) a unique key identifier (i.e., “K1” . . . “Kn”). Finally, UI generator 212 assigns the value of the key (i.e., the name or string used in display of the element, where in “name: John Doe” of a JSON notation, name is the key and “John Doe” is the value) a unique identifier (i.e., “S1” . . . “SN”). Based on the above designations the various UI elements have a unique identifier string of page/element/key/value to identify and track the location of UI elements during training.

In various embodiments, UI training data 214 also includes cluster information (i.e., “C1” . . . “Cn”) which assigns elements to the cluster. As previously stated, UI generator 212 can, in some scenarios, determine clusters based on nested elements in an interface notation. In other embodiments, UI training data 214 is pre-populated with pre-designed or existing interface clusters for the various elements. As used here, cluster refers to any grouping of multiple user interface elements. Furthermore, in some embodiments, based on the element aggregation where elements are assigned a unique string of page/element/key/value to identify and track the location of UI elements, once trained UI generator 212 can infer the clustering of elements based on string aggregation. For example, UI generator 212 will cluster elements with similar key names (i.e., “home address” and “work address”) or element names (i.e., “homeaddressfield” and “workaddressfield”).

Based on the UI training data 214, UI generator 212 trains deep learning models 215. In various embodiments, deep learning models 215 includes two machine learning clustering models, one semantic clustering model for UI elements (i.e., assigning the page/element/key/value identifier to an element) and one location clustering model for UI elements (i.e., the grouping of a collection of elements based on proximity). For the semantic clustering of UI elements, deep learning models 215 is configured to determine a semantic relevance between the various identifier strings of elements. For example, a string of values for one element P1/E1/K1/V1 has the values of the labels (e.g., “Main Page/Contact Field/Address/null” if the element was on a main page for a contact address info to be entered, with the filed empty or null). By comparing the semantic values of the various pages, elements and key/value pairs, deep learning models 215 learns similarities in the strings for clustering. As such, the elements do not need to exactly match, yet when enough similarity overlaps the clustering deep learning model for semantic clustering, the respective deep learning model 215 clusters similar elements based on the keys and values for the elements, as well as location within the pages of the interface as well as within a page itself.

In various embodiments, deep learning model 215 employ clustering algorithms that utilize unsupervised machine learning algorithm to groups data points together based on similarity, either semantic similarity or location similarity. Clustering algorithms are used to identify patterns and structure in data that may not be immediately apparent. Example clustering algorithms include, but are not limited to including density-based, distribution-based, centroid-based, hierarchical-based algorithms, K-means, DBSCAN, and hierarchical clustering.

In various embodiments, UI generator 212 trains deep learning model for clustering of UI elements based on both element identifier information as well as location information. As discussed herein, page/element/key/value identifiers are assigned to the various elements in a user interface. In addition to this information, UI generator 212 determines a display location for various elements. In some embodiments, UI generator 212 renders the user interface at a given resolution or other visual density measure to determine the spacing or location of the user interface elements. Those elements within a certain distance (e.g., within X pixels at a given resolution) are clustered. In other embodiments, UI training data 214 may include predetermined distances of UI elements from one another. Based on the training set, UI generator 212 trains deep learning model for clustering of UI elements to group elements that are similar in location.

As such, once trained, both deep learning models 215 cluster elements based on two separate criteria, semantic similarity of the elements (including not only the value but identifiers used to map which page, element, or key) for the semantic clustering of UI elements and location similarity of the elements for the clustering of UI elements. As such, deep learning models 215 both provide guidance for the expected clustering of elements in a translated user interface, grouping elements both on semantic similarity as well as location similarity. As discussed herein, when a user interface is translated and the new text values are inserted, UI generator 212 can determine if the new interface conforms the to the deep learning models 215 on both aspects. Therefore, improvements are made to automated translation of a user interface since embodiment of the present invention maintain both semantic similarity as well as location similarity when evaluating new translations.

Once deep learning models 215 have been trained on UI Training data 214, UI generator 212 is capable of generating translated UI data 218. First, a user supplies UI generator 212 with target UI data 216. Target UI data 216 is for a user interface in a first language that will be translated to one or more other languages. As discussed herein, like UI training data 214, target UI data 218 is represented using a known data exchange format, such as JSON.

First, UI generator 212 applies both the clustering models of deep learning models 215. UI generator 212 determines which elements to group or cluster based on a semantic relation established by the semantic clustering model, where page/element/key/value identifiers that are semantically similar are grouped together. UI generator 212 generates another grouping based on the position of elements, where nearby elements are grouped together. Based on the latent learnings of the semantic clusters and positional clustering of elements learned from UI training data 214, UI generator 212 determines which elements should be clustered based on either relationship.

In some embodiments, the clusterings from the respective models are maintained and evaluated separately. When evaluating translations, if either semantically related or positionally related elements are too far separated, then UI generator 212 will attempt to change the translated user interface to group elements of a similar cluster. In other embodiments, if UI generator 212 is satisfied with the position of translated elements in one model but not the other, then an attempt to change may be made. However, if no change can satisfy both models, then UI generator 212 selects a translation that satisfies only one model.

Once clusters have been determined for both models, UI generator 212 translates the element values for target UI data 216. Element labels or values are the text printed for a UI element that describes, otherwise indicates the function of the element (i.e., an elements “label”), or is text embedded in the user interface, such as a description (i.e., a elements “value”). For example, a “Send” button sends an email when clicked (i.e., the translated UI will translate the “Send” label for the element to the target language). Once each label and value of the UI is translated, UI generator 212 evaluate the resulting user interface. One of ordinary skill in the art will appreciate that any method for machine translation of text from one language to another may be used without deviating from the invention. In some scenarios, UI generator 212 generates multiple translation candidates for the target UI. When evaluation clustered elements that are too far away, UI generator 212 may choose to use a different translation to alter the layout of the user interface such that the clustered elements become closer based on the various candidate translations.

In various embodiments, UI generator 212 evaluates the translated UI. For each group of clustered elements, UI generator 212 determines the distance of the elements when the user interface is rendered. If the distance exceeds a threshold value, then UI generator 212 will attempt to alter the translated UI such that proximity of the elements in the luster is maintained in the translated UI. In various scenarios, UI generator 212 includes libraries, applications and other programming debugging features to render the user interface to determine the location and position of the elements when translated values are used. Based on this rendering, if the clustered elements are too far away, then UI generator 212 adjust the user interface such that clustered elements remain close. In some scenarios, UI generator 212 may insert blank spaces or other invisible user interface elements to push elements further together. In other scenarios, blank spaces may be removed to pull elements together. Furthermore, UI generator 212 may attempt another candidate translation of the various elements respective values or labels. A shorter or longer translation, even for other non-cluster elements, may cause other elements to be rendered closer. As such, UI generator 212 identifies other parts of the user interface that have other valid translations. Based on the need to either insert or remove spacing, a longer or shorter translation, respectively, may be used.

In various embodiments, once UI generator 212 determines a translation for the various elements and labels of the user interface that satisfies at least one of the deep learning models 215, then UI generator 212 provides Translated UI data 218 to the user. In some scenarios, UI generator 212 may provide a user interface onto itself to present the user with an enhanced view of the translated user interface highlighting or otherwise emphasizing the clusters of elements either positionally or semantically related. Based on the configuration, UI generator 212 maintains the proximity of either, and in some instances both, the semantic and location cluster.

In some embodiments, target UI data 216 may be a webpage. Many modern applications, while appearing to be standalone, are web-based applications. As such, UI generator 212 may be configured to target user interface of webpages by being supplied location information (i.e., a uniform resource locator (URL) or internet protocol (IP) address) to retrieve webpage UI data 222 to perform the same operations in respects to target UI data 216. Additionally, such embodiments of the present invention will enable quicker development pipelines for a webpage that serves a global audience.

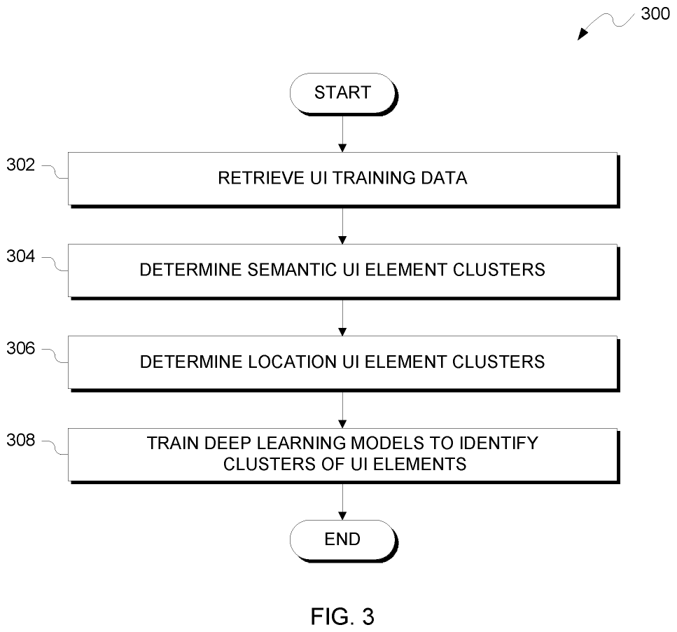

FIG. 3 illustrates operational processes, generally designated as 300, of training deep learning models 216 to classifying proximal elements in a user interface on both semantic and location relationship. In process 302. UI generator 212 retrieves UI training data 214. UI training data 214 includes a data representation of the user interface, such as JSON. UI generator 212 uses UI training data 214 to train deep learning models 215. In process 304, UI generator 212 determines sematic clusters for one or more groupings of elements. Based on the key-value pairs of the UI elements, where key indicates an element's name and value is the displayed value to a user, the semantic cluster model of deep learning models 215 identifies elements that are similar in sematic naming conventions. During development, programmers will often try and give descriptive names both to the elements as well as the text being displayed to a user. As such, the semantic cluster model is trained to classifying and cluster strings of key value pairs that are semantically similar.

In process 306, UI generator 212 determines location clusters for one or more groupings of elements. Based on the rendered user interface, the location model is supplied positional data for each element. This may be a pixel position, if rendered, or may be logical such as via a document of materials (DOM) in a webpage. The location model identifies elements that frequently appear proximal or near to one another. Based on the learnings in training, the deep learning models 215 determine patterns that indicate either semantic or location clustering in a user interface (process 308).

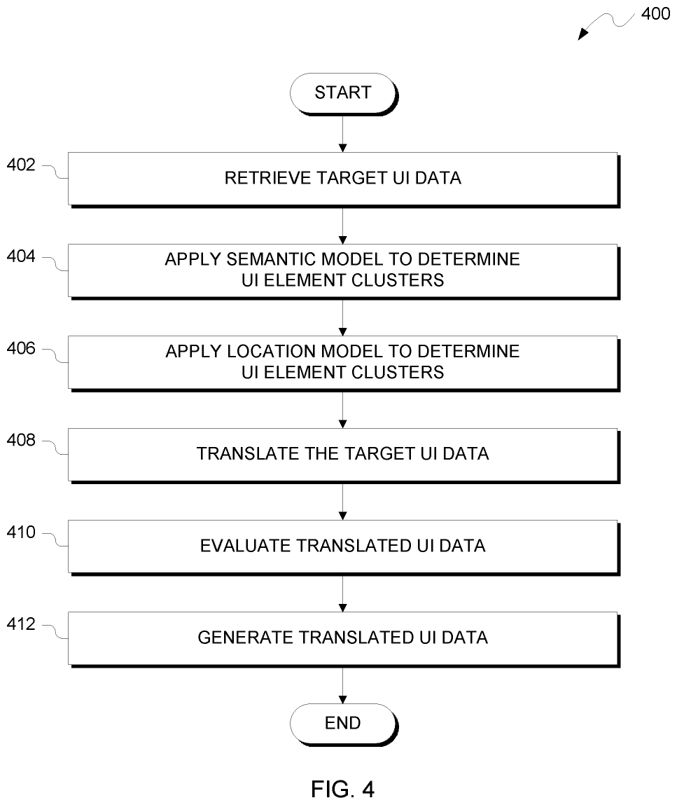

FIG. 4 illustrates operational processes, generally designated 400, of generating a translated user interface 218 based on analysis by trained deep learning models 215. In process 402, UI generator 212 retrieves target UI data 216. Target UI data 216, like UI training data 214, includes nomenclature to represent the user interface, such as JSON. In process 404, UI generator 212 applies the trained semantic model of deep learning models 215 to the target UI data 216. Based on the learnings gained during training, the semantic model determines key-value pairs that have semantically similar names, descriptions or text. In some scenarios, UI generator 212 trains the semantic model on other names and identifiers associated with target UI data 216, such as, but not limited to, file names, file paths and the like. In process 406, UI generator 212 applies the trained location model of deep learning models 215 to the target UI data 216. The location model, based on the learnings gained during training, identifies nearby UI elements and creates location clusters for elements.

In process 408, UI generator 212 translates the text of the user interface of target UI data 216. One of ordinary skill in the art will appreciate that any machine translation technique may be used without deviating from the invention such as, but not limited to, rule-based or neural network machine translation. Once the UI is translated, UI generator 212 evaluates the translated UI. If the translation moves elements in a cluster past a threshold value to the point where they are no longer considered proximal to the other elements in the cluster, then UI generator 212 alters the translated UI to attempt to maintain the elements in close proximity (process 410).

In some scenarios, UI generator may insert or delete blank spaces into the UI. For example, a <br> tag in html could be inserted to push elements further down a webpage or a “carriage return” or “line feed” could be added for push the elements further down a page. Similarly, blank spaces could be removed by UI generator 212 if elements need to closer to the cluster. Furthermore, UI generator may alter display properties such as font size and type to either “push” or “pull” elements in a similar fashion due to a size change of another element. In other scenarios, UI generator 212 may select another translation if the translation is shorter or longer than the current one. Given the need to either remove or add spacing, UI generator 212 may select a longer or shorter translation. Once the UI generator 212 determines a translated UI that maintains the proximity of elements in at least one cluster, then UI generator supplies the translated UI data 218 to the user (process 412).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method comprising:
retrieving, by one or more processors, a user interface for translation to a second language, wherein the user interface comprises a plurality of elements in a first language;
determining, by the one or more processors, at least one semantic cluster of the plurality of elements;
determining, by the one or more processors, at least one location cluster of the plurality of elements; and
generating, by the one or more processors, a translation of the plurality of elements in the first language to the second language, wherein the translation of the plurality of elements maintains proximity of i) the at least one semantic cluster of the plurality of elements or ii) the at least one location cluster of the plurality of elements.

2. The method of claim 1, wherein the at least one semantic cluster is determined based on a sematic similarity between labels or values of the plurality of elements in the user interface.

3. The method of claim 1, wherein the at least one location cluster of the plurality of elements is determined based on a rendered location of the plurality of elements in the user interface.

4. The method of claim 1, the method further comprising:
in response to the proximity of the plurality of elements in either the at least one location cluster or the at least one semantic cluster being not within a threshold value, selecting a different translation for at least one of the plurality of elements of the user interface.

5. The method of claim 1, the method further comprising:
in response to the proximity of the plurality of elements in either the at least one location cluster or the at least one semantic cluster being not within a threshold value, altering blank space in the user interface, wherein the blank space removes or inserts spacing to maintain proximity of i) the at least one semantic cluster of the plurality of elements or ii) the at least one location cluster of the plurality of elements.

6. The method of claim 1, wherein the at least one semantic cluster and the at least one location cluster are determined by a respective deep learning model.

7. The method of claim 6, wherein the respective deep learning models are trained using data representations of one or more pre-designed user interfaces.

8. A computer program product comprising:
one or more computer-readable storage media and program instructions stored on the one or more computer-readable storage media, the program instructions comprising:
program instructions to retrieve a user interface for translation to a second language, wherein the user interface comprises a plurality of elements in a first language;
program instructions to determine at least one semantic cluster of the plurality of elements;
program instructions to determine at least one location cluster of the plurality of elements; and
program instructions to generate a translation of the plurality of elements in the first language to the second language, wherein the translation of the plurality of elements maintains proximity of i) the at least one semantic cluster of the plurality of elements or ii) the at least one location cluster of the plurality of elements.

9. The computer program product of claim 8, wherein the at least one semantic cluster is determined based on a sematic similarity between labels or values of the plurality of elements in the user interface.

10. The computer program product of claim 8, wherein the at least one location cluster of the plurality of elements is determined based on a rendered location of the plurality of elements in the user interface.

11. The computer program product of claim 8, the method further comprising:
in response to the proximity of the plurality of elements in either the at least one location cluster or the at least one semantic cluster being not within a threshold value, selecting a different translation for at least one of the plurality of elements of the user interface.

12. The computer program product of claim 8, the method further comprising:
in response to the proximity of the plurality of elements in either the at least one location cluster or the at least one semantic cluster being not within a threshold value, altering blank space in the user interface, wherein the blank space removes or inserts spacing to maintain proximity of i) the at least one semantic cluster of the plurality of elements or ii) the at least one location cluster of the plurality of elements.

13. The computer program product of claim 8, wherein the at least one semantic cluster and the at least one location cluster are determined by a respective deep learning model.

14. The computer program product of claim 13, wherein the respective deep learning models are trained using data representations of one or more pre-designed user interfaces.

15. A computer system comprising:
one or more computer processors;
one or more computer readable storage media; and
program instructions stored on the computer readable storage media for execution by at least one of the one or more processors, the program instructions comprising:
program instructions to retrieve a user interface for translation to a second language, wherein the user interface comprises a plurality of elements in a first language;
program instructions to determine at least one semantic cluster of the plurality of elements;
program instructions to determine at least one location cluster of the plurality of elements; and
program instructions to generate a translation of the plurality of elements in the first language to the second language, wherein the translation of the plurality of elements maintains proximity of i) the at least one semantic cluster of the plurality of elements or ii) the at least one location cluster of the plurality of elements.

16. The computer system of claim 15, wherein the at least one semantic cluster is determined based on a sematic similarity between labels or values of the plurality of elements in the user interface.

17. The computer system of claim 15, wherein the at least one location cluster of the plurality of elements is determined based on a rendered location of the plurality of elements in the user interface.

18. The computer system of claim 15, the method further comprising:
in response to the proximity of the plurality of elements in either the at least one location cluster or the at least one semantic cluster being not within a threshold value, selecting a different translation for at least one of the plurality of elements of the user interface.

19. The computer system of claim 15, the method further comprising:
in response to the proximity of the plurality of elements in either the at least one location cluster or the at least one semantic cluster being not within a threshold value, altering blank space in the user interface, wherein the blank space removes or inserts spacing to maintain proximity of i) the at least one semantic cluster of the plurality of elements or ii) the at least one location cluster of the plurality of elements.

20. The computer system of claim 15, wherein the at least one semantic cluster and the at least one location cluster are determined by a respective deep learning model.
